(19) United States
(12) Patent Application Publication
(10) Pub. No.: US 2016/0068181 A1
(43) Pub. Date: Mar. 10, 2016

(54) ELECTRICALLY-DRIVEN STEERING COLUMN APPARATUS

(71) Applicant: FUJI KIKO CO., LTD., Kosai-shi (JP)

(72) Inventor: Toshihiko WARASHINA, Kosai-shi (JP)

(73) Assignee: FUJI KIKO CO., LTD., Kosai-shi (JP)

(21) Appl. No.: 14/844,260

(22) Filed: Sep. 3, 2015

(30) Foreign Application Priority Data
Sep. 8, 2014 (JP) 2014-181832

(51) Int. Cl. B62D 1/181; B62D 1/185

(52) U.S. Cl. CPC B62D 1/181; B62D 1/185

(57) ABSTRACT

Electrically-driven steering column apparatus including: lower jacket; upper jacket axially slidably inserted thereinto; and telescopic drive disposed astride these two jackets. The telescopic drive contains: support member; screw shaft connected to the support member; and electric motor unit fixed to the lower jacket. The screw shaft is rotatably driven by the motor unit to make slidable motion of the upper jacket with respect to the lower jacket thereby allowing telescopic operation. The lower jacket has axially extending evacuation section shaped by partially increasing the inner diameter of the lower jacket, thereby allowing the passage of nut member provided on the upper jacket. Attaching bolt is screwed into the nut member through longitudinally extending rectangular hole defined by the evacuation section. The support member is supported by the upper jacket through the attaching bolt. Pushing member is disposed circumferentially opposite to the evacuation section, for pushing the upper jacket inwardly.

### BACKGROUND OF THE INVENTION

The present invention relates to improvements in an electrically-driven steering column apparatus wherein its telescopic motion for adjusting the position of a steering wheel in an axial direction is adapted to be caused by electric power.

In a steering column apparatus equipped with a telescopic function, an upper jacket is axially movably fitted in a lower jacket supported on a vehicle body side while an electric drive for telescopic motion is disposed astride the lower and upper jackets. For example, the electric drive is comprised primarily of an electric motor unit supported with the lower jacket, a screw shaft that can move the upper jacket forward or backward by the activation of the electric motor unit, and a supporting member connecting one end of the screw shaft to the upper jacket.

With regard to such an electrically-driven steering column apparatus, Japanese Patent Application Publication No. 2001-018809 discloses a technique of so disposing a supporting member as to coincide with a part where an upper jacket (an inner cylinder) and a lower jacket (an outer cylinder) are fitted in order to achieve a longitudinal downsizing of the steering column apparatus. More specifically, the apparatus disclosed in Japanese Patent Application Publication No. 2001-018809 takes on a structure where the lower jacket is provided to have an opening through which the supporting member is inserted and the supporting member is fixed to the upper jacket (located inside the lower jacket) through a preparatory plate by a bolt.

Meanwhile, Japanese Patent Application Publication No. 2002-160646 discloses that a lower jacket is provided to have an edge portion defining an opening and a supporting member is directly brought into contact with the edge portion of the lower jacket. A bolt inserted into the supporting member is provided to penetrate through the opening and the upper jacket, and screwed into a preparatory plate disposed along an inner periphery of the upper jacket thereby fixing the supporting member. With this, a rattling which may be caused due to a gap between the lower and upper jackets is prevented.

### SUMMARY OF THE INVENTION

However, drawbacks have been encountered in the above discussed conventional steering column apparatus. More specifically, in the technique disclosed by Japanese Patent Application Publication No. 2001-018809 where the preparatory plate to be threadedly engaged with the bolt for fixing the supporting member is located inside the upper jacket, not only the assembling property of the preparatory plate on the upper jacket is not good but also the above preparatory plate structure cannot be adopted if a gap between the upper jacket and a steering shaft which is to be inserted into the upper jacket is narrow.

In the technique disclosed by Japanese Patent Application Publication No. 2002-160646, the upper and lower jackets are interposed between the preparatory plate disposed inside the upper jacket and the supporting member, which raises a fear of causing a malfunction due to a hitch or an increase of slide resistance at the time of the telescopic operation.

In view of the above problems, an object of the present invention is to provide an improved electrically-driven steering column apparatus which can effectively overcome drawbacks encountered in conventional techniques.

Another object of the present invention is to provide an improved electrically-driven steering column apparatus ensuring the rigidity of the lower jacket and improved in assembling property.

The present invention relates to an electrically-driven steering column apparatus comprising: (i) a lower jacket; (ii) an upper jacket inserted into the lower jacket in a manner to be slidable in the axial direction; and (iii) a telescopic drive disposed astride the lower jacket and the upper jacket so as to bridge therebetween, the telescopic drive comprising: (1) a support member attached to the upper jacket; (2) a screw shaft the one end of which is connected to the support member; and (3) an electric motor unit fixed to the lower jacket, wherein the screw shaft is rotatably driven by the electric motor unit to make a slidable motion of the upper jacket with respect to the lower jacket thereby allowing a telescopic operation.

A first aspect of the present invention resides in that the above-mentioned electrically-driven steering column apparatus is characterized by providing a nut member on the outer peripheral surface of the upper jacket. Additionally, the lower jacket is formed having: a cylindrical section into which the outer peripheral surface of the upper jacket is fitted; and an evacuation section shaped by increasing one region of the inner peripheral surface of the cylindrical section and shaped extending in the axial direction thereby accepting the nut member and allowing the passage of the nut member. Furthermore, the evacuation section is formed with a rectangular hole defined extending in the longitudinal direction to correspond the nut member throughout the range of the telescopic operation. An attaching bolt is inserted piercing the rectangular hole and screwed into the nut member, through which the support member is supported by the upper jacket. Moreover, the lower jacket is provided with a pushing member at a location circumferentially opposite to that of the evacuation section, for pushing the upper jacket inwardly.

A second aspect of the present invention resides in that the electrically-driven steering column apparatus as discussed in the first aspect of the present invention is characterized in that the support member is supported to be swingable about the attaching bolt.

A third aspect of the present invention resides in that the electrically-driven steering column apparatus as discussed in the second aspect of the present invention is characterized in that the attaching bolt comprises, from one end thereof: a male thread portion threadedly engageable with the nut member; a first axial portion onto which a cushion member is fitted, the cushion member being brought into contact with the outer surface of the periphery of the rectangular hole which periphery is defined by the evacuation section; a flange portion larger than the first axial portion in diameter to restrict the axial movement of the cushion member; a second axial portion on which the support member is swingably supported; and a fixer portion to which a member for restricting the axial movement of the support member and preventing the support member from falling out is fitted.

The other objects and features of this invention will become understood from the following description with reference to the accompanying drawings.

### BRIEF DESCRIPTION OF THE DRAWING

FIG. 1 is a cross-sectional explanatory view of an embodiment of an electrically-driven steering column apparatus according to the present invention, which is taken along the line A-A of FIG. 2;

FIG. 2 is a cross-sectional explanatory view of the electrically-driven steering column apparatus, taken along the line B-B of FIG. 1; and

FIG. 3 is an exploded perspective view for explaining a relationship between lower and upper jackets shown in FIGS. 1 and 2.

### DETAILED DESCRIPTION OF THE INVENTION

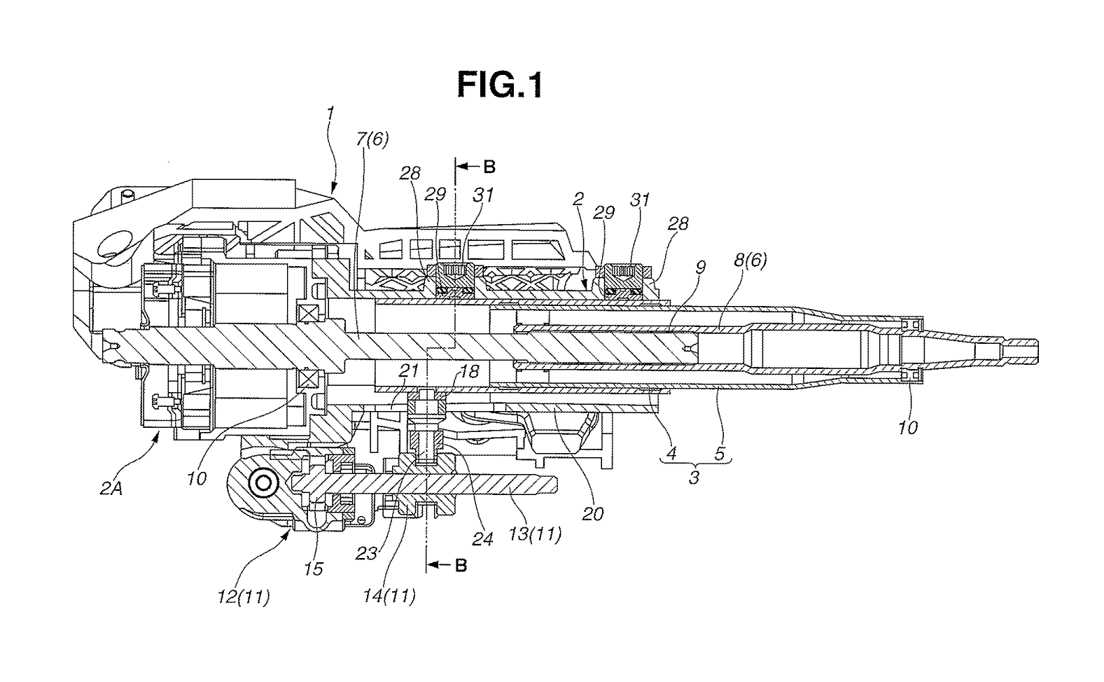

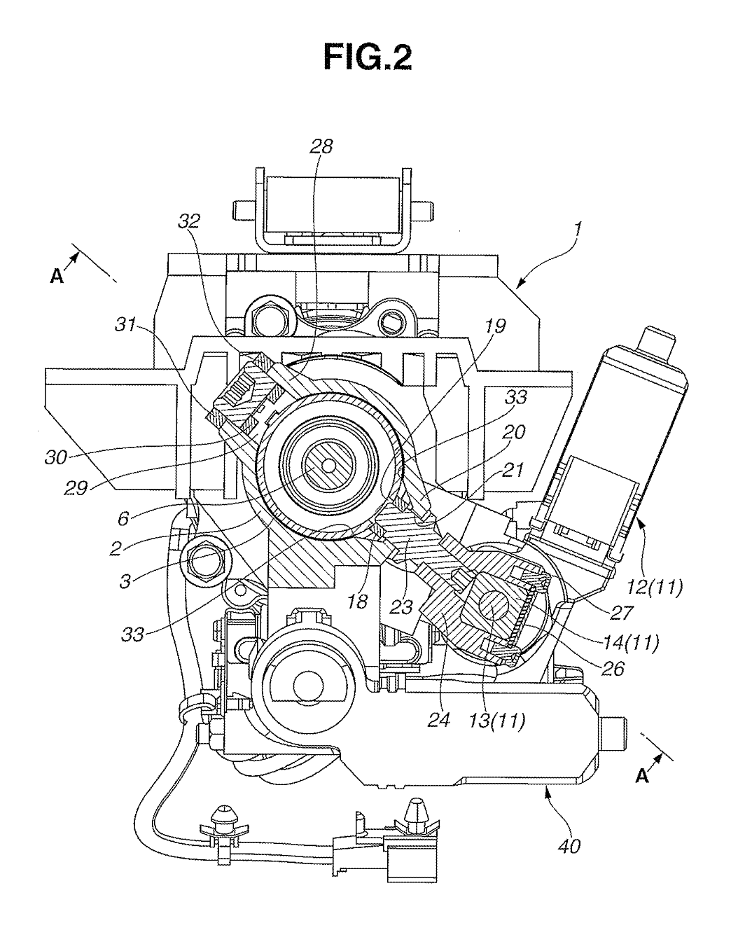

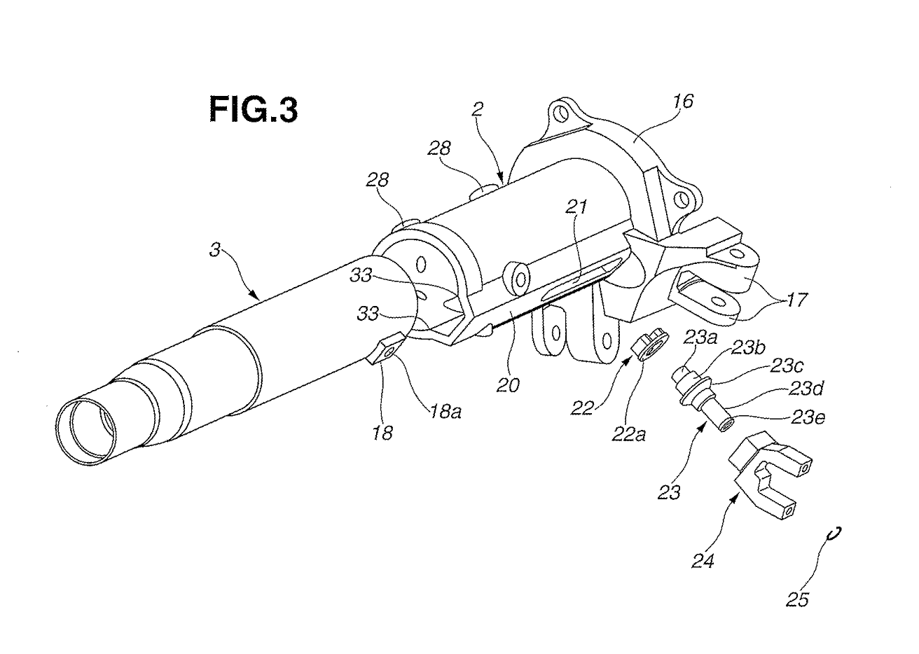

Referring now to the accompanying drawings, a first embodiment of an electrically-driven steering column apparatus according to the present invention is illustrated. FIG. 1 is a cross-sectional explanatory view taken along the line A-A of FIG. 2, i.e., a longitudinal cross-sectional view taken along the length of the electrically-driven steering column apparatus. FIG. 2 is a cross-sectional explanatory taken along the line B-B of FIG. 1. Moreover, FIG. 3 is an exploded perspective view showing a relationship between a lower jacket 2 and an upper jacket 3 of the electrically-driven steering column apparatus.

As shown in FIG. 1, the lower jacket 2 is provided to have a generally hollow cylindrical shape and fixedly supported by a highly-rigid mounting bracket 1 which is to be fixed on the side of a vehicle body. The upper jacket 3 having the same shape (a generally hollow cylindrical shape) is inserted into the lower jacket 2 in such a manner as to be slidable in the axial direction with respect to the lower jacket 2. Into the interior of the lower jacket 2 and the upper jacket 3, a steering shaft 6 is inserted penetratingly concentrically with them. The steering shaft 6 is comprised of a lower shaft 7 and an upper shaft 8 spline-connected to each other at a male/female spline connecting portion 9, and rotatably supported through a plurality of bearings 10. To an end of the upper shaft 8, a steering wheel is attached (though not shown).

The upper jacket 3 is composed of an upper jacket lower 4 directly inserted into the lower jacket 2, and an upper jacket upper 5 axially slidably inserted into the upper jacket lower 4 in a tightly fitting manner. Incidentally, the sliding actions of the upper jacket lower 4 and the upper jacket upper 5 function as a part of a collision energy-absorbing mechanism at the time of a secondary collision, and therefore not relate to the present invention directly. Hence the upper jacket lower 4 and the upper jacket upper 5 will not be referred to separately, and the term “the upper jacket 3”, a generic name for both will hereinafter be used. While the mounting bracket 1 and the lower jacket 2 are shaped by die casting such as aluminum die casting, the upper jacket 3 to be used is one obtained by processing a metal pipe e.g. a steel pipe.

A telescopic drive (hereinafter referred to as merely a drive) 11 for the telescopic operation is disposed astride the lower jacket 2 and the upper jacket 3 so as to bridge therebetween. The drive 11 is comprised primarily of: an electric motor unit 12 the overall structure of which is illustrated in FIG. 1; a screw shaft or screw axis 13 rotatably driven by the motor unit 12 through a drive gear and a driven gear 15; and a driven nut member 14 screwed onto the screw shaft 13. The motor unit 12 is integrally constructed from an electric motor and a reduction gear, and the screw shaft 13 is disposed parallel with the steering shaft 6.

Meanwhile, a substantially bifurcated support bracket 24 serving as a support member is attached to the upper jacket 3 through an attaching bolt 23 as shown in FIG. 3. To the support bracket 24, the above-mentioned driven nut member 14 is non-rotatably fixed. With this structure, when the screw shaft 13 is driven in a normal or reverse direction by the activation of the motor unit 12, the driven nut member 14 screwed together with the screw shaft 13 comes to be moved forward or backward, with which the upper jacket 3 is moved forward or backward with respect to the lower jacket 2 thereby accomplishing the telescopic operation.

Though a motor unit 40 different from the above-mentioned motor unit 12 is also provided as shown in FIG. 2, this is for a tilt mechanism often used in combination with the telescopic mechanism and not relate to the present invention directly; therefore, a detailed description about the motor unit 40 is omitted in this specification.

FIG. 3 is an exploded perspective view extracting only the lower jacket 2 and the upper jacket 3 of FIG. 1. As shown in FIG. 3, the lower jacket 2 is includes a cylindrical section at one end, and a bottom flange section 16 at the other end. The bottom flange section 16 is provided for fixing a detection unit 2A (supported by the mounting bracket 1 as shown in FIG. 1), and formed integral with the cylindrical section. Additionally, the lower jacket 2 is formed further with a motor bracket 17 so as to extend a part of the bottom flange section 16.

As shown in FIG. 3, the upper jacket 3 has an insertion-starting end side from which insertion into the lower jacket 2 is to be started, and a square-shaped weld nut 18 is fixedly disposed on the outer peripheral surface of the insertion-starting end side of the upper jacket 3. The weld nut 18 is formed with a female thread portion 18a. The upper jacket 3 has, at a part corresponding to the female thread portion 18a, a clearance hole 19 as shown in FIG. 2.

Meanwhile, the lower jacket 2 as shown in FIG. 3 is formed having a longitudinally extending evacuation section 20 for accepting the insertion of the upper jacket thus provided with the weld nut 18, the evacuation section 20 being formed in such a manner as to extrude one region of the inner peripheral surface of the cylindrical section outwardly to define a generally trapezoidal cross section. Furthermore, the lower jacket 2 has a rectangular hole 21 at the top of the evacuation section 20, the rectangular hole 21 being defined extending in the longitudinal direction so as to correspond to the position of the weld nut 18 throughout the range of the telescopic motion. With this arrangement, the lower jacket 2 can smoothly accept the upper jacket 3 accompanied with the weld nut 18 by inserting the upper jacket 3 while bringing the phase of the evacuation section 20 and that of the weld nut 18 into agreement with each other, and additionally relative sliding motions between the lower jacket 2 and the upper jacket 3 can smoothly be achieved within a certain range. Incidentally, the length of the rectangular hole 21 corresponds to the stroke of the telescopic operation based on the sliding motion of the upper jacket 3 relative to the lower jacket 2, as mentioned below.

As shown not only in FIG. 3 but also in FIGS. 1 and 2, a resinous stopper 22 serving as a cushion member is fitted to the attaching bolt 23 and then the attaching bolt 23 is inserted into the lower jacket 2 from the side of the rectangular hole 21 and screwed into the weld nut 18 (provided on the side of the upper jacket 3) under the condition that the upper jacket 3 is inserted into the lower jacket 2 and the weld nut 18 on the side of the upper jacket 3 and the rectangular hole 21 on the side of the lower jacket 2 are brought into agreement with each other, thereby fixing the attaching bolt 23 to the upper jacket 3.

Furthermore, the bifurcated support bracket 24 as shown in FIG. 3 is fitted at its root-like part to the attaching bolt 23 fixed to the upper jacket 3, and then a snap ring 25 that serves as a member preventing the support bracket 24 from falling out is attached to the attaching bolt 23. With this, the support bracket 24 is supported by the attaching bolt 23 in such a manner as to be swingable about the attaching bolt 23.

As shown in FIG. 2, the support bracket 24 defines a space between its bifurcated branches, into which the driven nut member 14 of the telescopic drive is non-rotatably fitted. By fastening a holder plate 26 to the support bracket 24 with screws 27, it becomes feasible to prevent the support bracket 24 from falling out.

Additionally, as obvious from FIG. 3, the stopper 22 is provided to have: a larger-diameter flange region 22a which can be brought into contact with the periphery of the rectangular hole 21 of the evacuation section 20; and the other region to be inserted into the rectangular hole 21. With this arrangement, the stopper 22 can be moved together with the attaching bolt 23 along the rectangular hole 21 at the time of the telescopic operation based on the sliding motion of the upper jacket 3 relative to the lower jacket 2, thereby allowing a smooth telescopic operation.

By the way, the rectangular hole 21 is provided to have a length corresponding to the stroke of the telescopic operation as mentioned above. Accordingly, at a stroke end of the telescopic operation, the resinous stopper 22 fitted to the attaching bolt 23 is brought into contact with the inner wall surface of a longitudinal one end or the other end of the rectangular hole 21 thereby restricting a farther stroke while simultaneously preventing the generation of striking noise and the like.

As shown in FIG. 3, the attaching bolt 23 is provided to have a multistage shape including, in the order of decreasing proximity to the tip end of the attaching bolt 23: a male thread portion 23a threadedly engageable with the weld nut 18 fixed to the upper jacket 3; a first axial portion 23b onto which the resinous stopper 22 is fitted, and inserted into the rectangular hole 21 formed at the evacuation section 20; a larger-diameter flange portion 23c for restricting the position of the stopper 22; a second axial portion 23d to which the root-like part of the support bracket 24 is fitted; and an annular groove 23e formed at a tip end of the second axial portion 23d to serve as a portion fixing the snap ring 25 (a member for preventing the attaching bolt 23 from falling out) attached thereto.

As shown in FIGS. 1 to 3, the lower jacket 2 has two annular projections 28 respectively at two locations separated in the longitudinal direction and circumferentially opposite to the evacuation section 20, the annular projections 28 being shaped like a boss which communicates with the interior of the lower jacket 2. As shown in FIG. 2, each of the annular projections 28 constitutes a female screw at its inner peripheral surface, into which a pusher 29 serving as a pushing member is inserted together with a plurality of disc springs 30. The pusher 29 and the disc springs 30 are tightly fastened by an adjusting bolt 31 threadedly engaged with the female screw formed on the inner peripheral surface of the annular projection 28. The adjusting bolt 31 constitutes a male screw on its outer peripheral surface, with which a locknut 32 is engaged. With such a structure, looseness of the adjusting bolt 31 is prevented.

Since the pusher 29 is biased by the disc springs 30 to be pushed against the outer peripheral surface of the upper jacket 3, the upper jacket 3 is pushed against the inner peripheral surface of the lower jacket 2 or pushed toward the side of the evacuation section 20 of the lower jacket 2. More specifically, as shown in FIG. 2, the outer peripheral surface of the upper jacket 3 biased by the pusher 29 is hard pressed onto the inner peripheral surface of the lower jacket 2 at ridgeline sections 33 (formed by the both sides of the rectangular hole 21 and the evacuation section 20 as shown in FIG. 3). The upper jacket 3 is therefore adapted to be held under constraint in the lower jacket 2, with the so-called three-point supported structure established by the pusher 29 and a pair of ridgeline sections 33 regardless of whether it is under the telescopic operation or not.

According to the thus constructed steering column apparatus, the condition as shown in FIGS. 1 and 2 is self-kept at a steady state or at the time of not executing the telescopic operation. In particular, the upper jacket 3 is firmly held under constraint in the lower jacket 2 due to the three-point supported structure as shown in FIG. 2, with which the rotation of the steering shaft 6 depending on the operation of the steering wheel (though not shown) is smoothly accepted.

At the time of adjusting the position of the steering wheel in the axial direction, a not-illustrated telescopic switch is turned to “elongation mode” or “contraction mode”. With this, the motor unit 12 of the telescopic drive 11 is activated to drive the screw shaft 13 disposed parallel with the steering shaft 6 in the normal or reverse direction. Concurrently with the rotation of the screw shaft 13, the driven nut member 14 threadedly engaged with the screw shaft 13 as shown in FIG. 1 is moved rightward or leftward of FIG. 1 along the screw shaft 13.

When the driven nut member 14 is moved in either direction, the support bracket 24 which supports the driven nut member 14 is moved also in the same direction along the length direction of the rectangular hole 24 together with the attaching bolt 23 and the stopper 22. Since the attaching bolt 23 is screwed into the weld nut 18 fixedly provided on the upper jacket 3 as mentioned above, the upper jacket 3 connected to the attaching bolt 23 can slidably be moved with respect to the lower jacket 2 as a result thereby accomplishing its telescopic operation. With this arrangement, it is possible to adjust the axial position of the steering wheel to an arbitrary position within the range of the length of the rectangular hole 21.

Particularly regarding the structure itself of the steering column apparatus, the upper jacket 3 is provided fixedly with the weld nut 18 while the lower jacket 2 is partially increased in diameter to form the evacuation section 20 for accepting the passage of the weld nut 18. With such a structure, the only thing we have to do when attaching the upper jacket 3 to the lower jacket 2 as shown in FIG. 3 is to insert the upper jacket 3 into the lower jacket 2 upon aligning the phase of the evacuation section 20 with that of the weld nut 18. Thus, the weld nut 18 never hinders attachment of the upper jacket 3 to the lower jacket 2, and therefore an excellent assembling property is achieved. In addition, the operational stability at the time of the telescopic operation is also excellently ensured. Furthermore, the rectangular hole 21 defined by the evacuation section 20 does not open up to a longitudinal end of the lower jacket 2, thereby highly ensuring the rigidity of the lower jacket 2 formed having the evacuation section 20.

When directing attention to the relationship between the attaching bolt 23 and the pusher 29 as shown in FIG. 2, it will be found that the pusher 29 is disposed at a location opposite to that of the attaching bolt 23 and that the upper jacket 3 receiving a biasing force from the pusher 29 is hard pressed onto the inner peripheral surface of the lower jacket 2, and more specifically, hard pressed onto the ridgeline sections 33 (behaving as a pair of corner-like both side sections that construct the evacuation section 20 therebetween). When viewed in the cross section as shown in FIG. 2, the upper jacket 3 inserted into the lower jacket 2 is therefore supported at three points consisting of both of the ridgeline sections 33 (interposing the evacuation section 20) and the pusher 29, as mentioned above. With this, it is possible to prevent a rattling which may be caused between the upper jacket 3 and the lower jacket 2, thereby improving the support rigidity of the upper jacket 3.

Moreover, the support bracket 24 connected to the upper jacket 3 through the attaching bolt 23 has flexibility in swing about the axis of the attaching bolt 23, so that it is possible to absorb distortion of the screw shaft 13 which may occur during the telescopic operation and additionally it is also possible to prevent the generation of an abnormal noise resulting from the distortion.

Still further, as shown in FIG. 3, the attaching bolt 23 is provided to include, in the order of decreasing proximity to the tip end of the attaching bolt 23: a male thread portion 23a; a first axial portion 23b; a larger-diameter flange portion 23c; a second axial portion 23d; and an annular groove 23e for fixing the snap ring 25. With this arrangement, the assembling operation can be attained by a step of attaching the support bracket 24 to the attaching bolt 23 in the state of the attaching bolt 23 having been screwed into the weld nut 18 together with the stopper 22 and a subsequent step of mounting the snap ring 25 in order to prevent the attaching bolt 23 from falling out. It is therefore also possible to obtain a good assembling workability.

The entire contents of Japanese Patent Application 2014-181832 filed Sep. 8, 2014 are herein incorporated by reference.

Although the invention has been described above by reference to certain embodiments and examples of the invention, the invention is not limited to the embodiments and examples described above. Modifications and variations of the embodiments and examples described above will occur to those skilled in the art, in light of the above teachings. The scope of the invention is defined with reference to the following claims.

What is claimed is:

1. An electrically-driven steering column apparatus comprising:
(i) a lower jacket;
(ii) an upper jacket inserted into the lower jacket in a manner to be slidable in the axial direction; and
(iii) a telescopic drive disposed astride the lower jacket and the upper jacket so as to bridge therebetween, the telescopic drive comprising:
(1) a support member attached to the upper jacket;
(2) a screw shaft the one end of which is connected to the support member; and
(3) an electric motor unit fixed to the lower jacket,
wherein the screw shaft is rotatably driven by the electric motor unit to make a slidable motion of the upper jacket with respect to the lower jacket thereby allowing a telescopic operation,
wherein
a nut member is provided on the outer peripheral surface of the upper jacket,
the lower jacket is formed having: a cylindrical section into which the outer peripheral surface of the upper jacket is fitted; and an evacuation section shaped by increasing one region of the inner peripheral surface of the cylindrical section and shaped extending in the axial direction thereby accepting the nut member and allowing the passage of the nut member,
the evacuation section is formed with a rectangular hole defined extending in the longitudinal direction to correspond the nut member throughout the range of the telescopic operation,
an attaching bolt is inserted piercing the rectangular hole and screwed into the nut member, through which the support member is supported by the upper jacket, and
the lower jacket is provided with a pushing member at a location circumferentially opposite to that of the evacuation section, for pushing the upper jacket inwardly.

2. An electrically-driven steering column apparatus as claimed in claim 1, wherein the support member is supported to be swingable about the attaching bolt.

3. An electrically-driven steering column apparatus as claimed in claim 2, wherein the attaching bolt comprises, from one end thereof:
a male thread portion threadedly engageable with the nut member;
a first axial portion onto which a cushion member is fitted, the cushion member being brought into contact with the outer surface of the periphery of the rectangular hole which periphery is defined by the evacuation section;
a flange portion larger than the first axial portion in diameter to restrict the axial movement of the cushion member;
a second axial portion on which the support member is swingably supported; and
a fixer portion to which a member for restricting the axial movement of the support member and preventing the support member from falling out is fitted.
